(19) United States
(12) Patent Application Publication
(10) Pub. No.: US 2014/0046227 A1
(43) Pub. Date: Feb. 13, 2014

(54) CHEST CONTAINMENT SYSTEM AND METHOD

(71) Applicant: Hayden R Fleming, Scottsdale, AZ (US)

(72) Inventor: Hayden R Fleming, Scottsdale, AZ (US)

(21) Appl. No.: 13/870,133

(22) Filed: Apr. 25, 2013

Related U.S. Application Data
(60) Provisional application No. 61/675,657, filed on Jul. 25, 2012.

(51) Int. Cl. A61H 31/00

(52) U.S. Cl. CPC A61H 31/007
USPC 601/41

(57) ABSTRACT

A chest containment system incorporates a restraint for circumscribing a patient's chest and having a handle attached to or contacting the restraint that is positionable over the patient's sternum. The handle is adapted to be grasped by an operator or first responder's hand to apply a downward force to the sternum and followed by an upward force, creating tension in the restraint, to increase the efficacy of resuscitation and enhance perfusion and veinous return.

### RELATED APPLICATIONS

This application is related to and claims priority to a provisional application entitled “CHEST CONTAINMENT SYSTEM” filed Jul. 25, 2012, and assigned Ser. No. 61/675,657.

### FIELD OF THE INVENTION

The present invention relates to the administration of cardiopulmonary resuscitation and more particularly to an apparatus to facilitate increased efficacy of resuscitation techniques.

### BACKGROUND OF THE INVENTION

The performance of manual cardiopulmonary resuscitation (CPR) by first responders of sudden cardiac arrest victims is disappointing despite years of extensive efforts and training by the American Heart Association and other organizations to improve the application of CPR and survival rates for the victims. The standards for manual CPR are the American Heart Association guidelines which call for at least 100 compressions per minute to a sternal depth of two inches into the chest when using manual compression technique. This standard is difficult to meet manually and generally cannot be sustained for more than a few minutes although the first responder may be physically fit. Systems that increase the efficiency of resuscitation efforts have generally been directed to the replacement of the manual compressions required for proper performance and administration of CPR.

Such replacement systems are typically pneumatically or electrically powered. These powered systems are frequently awkward to use and sometimes are less than optimal, especially in the rapid development of activities surrounding an occasion of cardiac arrest. The initial moments upon the arrival of first responders to a cardiac arrest victim are absolutely critical to the administration of the procedure and thus to increase the survival of the victim. Thus, complex mechanical systems, whether pneumatic or electrical powered, manipulation sometimes require the expenditure of precious seconds to properly mount, secure, and initiate action. Further, the efficacy of the compression strokes by current powered systems may have varying success in the appropriate stimulation of the victim's heart. Portability and simplicity of systems for CPR are essential attributes of such systems but frequently they exhibit deleterious effects on the rapid initiation of the CPR procedure.

### SUMMARY OF THE INVENTION

A restraint comprising a belt or strap having a minimum width is provided for circumscribing a patient's chest. The restraint is positioned on the patient's chest and tensioned; a handle is connected to or placed in contact with the restraint and incorporates a grip to be grasped by a first responder or operator. The handle is positionable to permit the handle to be placed in contact with the patient's sternum. The operator may then apply compressive forces to the sternum while the restraint contains the chest to direct the compressive forces inwardly toward the patient's heart. Upon completion of the downward or compressive stroke by the operator, the operator then reverses the motion and draws the handle upwardly to thus remove the compressive forces previously applied to the sternum and instead tension the restraint to apply forces to the back and sides of the chest to thereby reverse the direction of forces being applied to the patient.

### BRIEF DESCRIPTION OF THE DRAWINGS

The present invention may more readily be described by reference to the accompanying drawings in which:

FIG. 1 is a perspective view showing the restraint portion of the system of the present invention positioned on a patient.

FIG. 2 is an enlarged perspective view of the buckle shown in FIG. 1.

FIG. 3 is a partial cross-sectional view of the restraint and buckle of the present invention taken along line 3-3 of FIG. 4.

FIG. 4 is a top view of the buckle and restraint used in the system of the present invention showing the attachment of the restraint to the buckle.

FIG. 5 is a side elevational view of the handle used in the system of the present invention.

FIG. 6 is a perspective view of the handle of FIG. 5.

FIG. 7 is a perspective view of the chest containment system of the present invention positioned on a patient.

FIG. 8 is a perspective view of the restraint and handle of the system of the present invention showing the incorporation of a tension indicating device positioned on the restraint.

FIG. 9 is a perspective view of another embodiment of the restraint and handle incorporated in the chest containment system of the present invention.

FIG. 10 is a cross-sectional view of the embodiment shown in FIG. 9 taken along line 10-10.

### DETAILED DESCRIPTION OF THE INVENTION

Applying pressure to the chest, usually to the area of the sternum, creates pressure force directed into the patient's chest resulting in the attempt of the chest cavity to deform; the present invention's restraint restricts such deformation or substantial expansion and thus encourages profusion. Prior art techniques including manual or electrical/pneumatic resuscitation systems then release the pressure and permit the muscular and skeletal structure of the patient's chest cavity restore its former position. The present system provides the same pressure application and chest restraint to encourage perfusion; however, this pressure application is not simply removed, but is reversed. That is, the operator or first responder applies pressure as in the prior art and subsequently reverses the force on the system handle (to be described) by lifting the handle. The forces applied to the patient's chest no longer emanate from the sternum area of the patient, but now are applied through the restraint to the back and sides of the patient's chest that are contacted by the restraint. The restraint is now being tensioned by the upward stroke of the responder's arm acting through the handle. Thus, the pressure source applied to the chest cavity is essentially reversed. It is believed that this reversal of pressure application to the patient's chest enhances the implementation of perfusion activity throughout the chest cavity and particularly in the area of the patient's heart.

The present invention is directed to increasing the efficacy of manual CPR to assist those administering CPR to more effectively utilize their efforts of manual resuscitation. As CPR is performed, the chest containment system of the present invention contains the compressive forces created by force applied to the sternum and directs these forces toward the heart. Without the restraint afforded by the present invention, the compression forces are diminished as the rib cage expands laterally during the compression stroke. When the compression stroke is completed, prior art systems merely rely on the removal of compression force to permit the patient's chest to return to its original state by reason of the musculature and skeletal structure of the patient. The present invention provides a means for reversing the compression stroke to subsequently apply a reversal of force creating a lifting tension in the circumscribing chest restraint. The reversal force is believed to facilitate the repositioning of the skeletal structure, particularly the sternum, to its original pre-CPR position while enhancing perfusion and veinous return.

The present design of the chest containment system provides a restraint that circumscribes the chest at the desired position and may be secured to the victim in a manner to be described. The restraint is preferably a minimum of 6 inches wide and approximately 80 inches long to assure that it can be used on chests ranging from 31 to 55 inches in circumference. The restraint is made of laminated fabric and sufficiently flexible to conveniently be wrapped about the victim's chest while incorporating sufficient transverse stiffness to avoid deformation of the restraint as it is tightened about the victim's chest and as compressions are applied to the chest. Typically, the fabric is laminated and may be constructed of a variety of commercially available fabrics such as nylon or similar polymeric fibers.

The chest containment system of the present invention provides flexibility in its application since it can be adapted for both manual and mechanical CPR and provides means for attaching a handle or gripping devices at a strategic location. For example, if the condition of the patient permits the expenditure of the required time, a mechanical chest compressor can be attached to the chest containment system in a variety of connection schemes although the chest containment system primarily permits manual compression to be performed without adding any external devices simply by securing the chest containment system to the victim in a manner to be described and manually compressing the chest at the sternum.

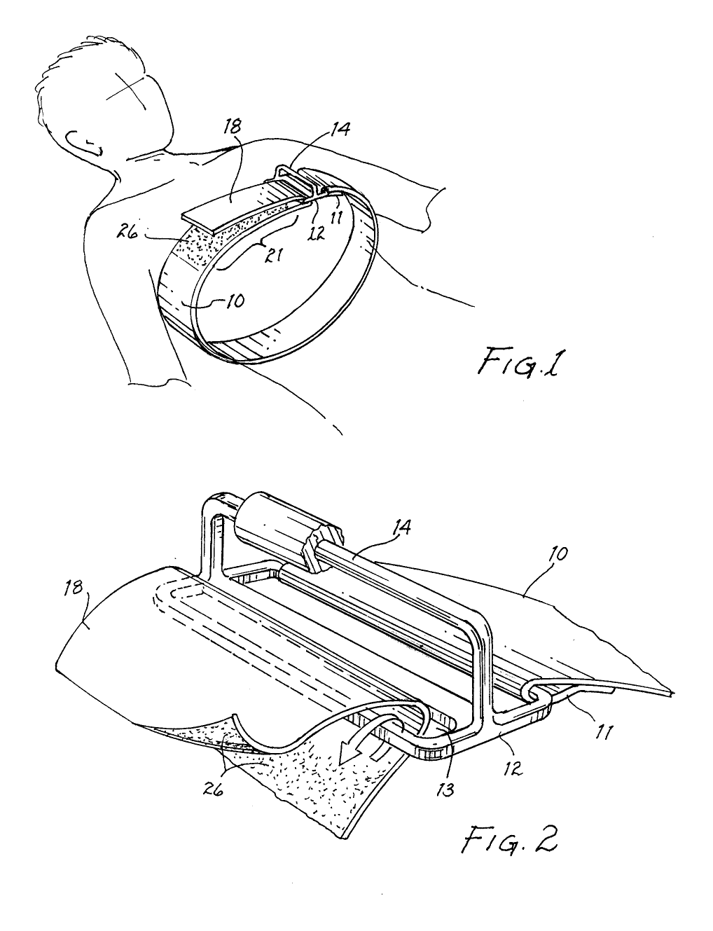

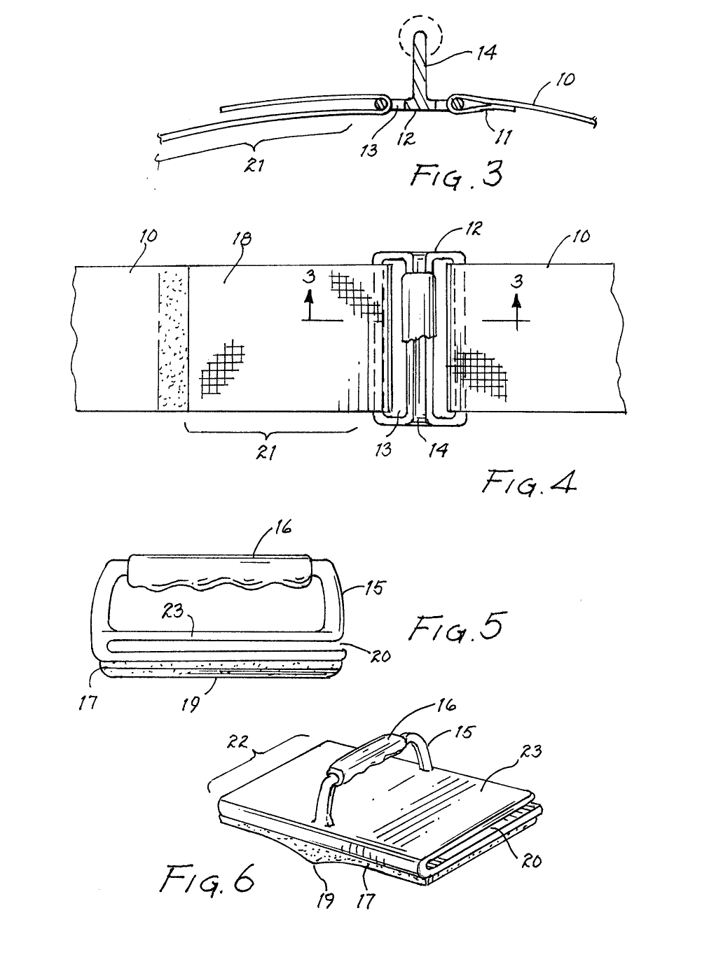

Referring to FIGS. 1 through 4, a schematic perspective drawing of the restraint used in the containment system of the present invention is shown. The restraint 10 circumscribes the patient's chest and is wide enough to accommodate the tension experienced during the application of force to the patient's chest to thus restrain displacement of the chest and promote perfusion. However, the width of the restraint is chosen to ensure adequate containment of the chest during CPR while providing sufficient contact area with the patient's chest to prevent injury that may result if the restraint were too narrow. The restraint is provided with a buckle 12 to which one end 11 of the restraint is permanently secured and which provides a buckle loop 13 at its opposite side to receive the loose restraint end 18. The loose restraint end 18 is thus threaded through the buckle loop 13 and manually pulled to thus supply substantial tension to the restraint and tightly secure the restraint about the patient's chest. A hook and loop surface 26 is provided on the restraint to permit the loose restraint end 18, after the restraint is appropriately tightened about the patient, to be secured and thus provide a length 21 of the restraint 10 that is a double thickness. The double thickness adds a measure of stiffness to the restraint to facilitate contact with a handle (to be described).

The buckle 12 is provided with a buckle grip 14 that may take several forms; in the embodiment shown in FIG. 1 the buckle grip 14 may be padded to be gripped by the operator to properly position the buckle 12 off to the side of the patient's chest. That is, the buckle 12 should be positioned toward the side of the patient's chest to permit the double thickness portion of the mounted restraint to be in contact with and covering the sternum and central portion of the patient's chest. The buckle 12, and the buckle grip 14, permits the operator to properly position the buckle and maintain that position while the loose restraint end 18 is threaded through the buckle loop 13 and drawn to an appropriate tension to provide the necessary pressure from the restraint against the person's chest. The buckle grip 14 may take various forms, and could be a simple raised ledge extending the width of the buckle of sufficient height from the buckle to permit the operator to grasp the raised ledge and maintain the buckle in position as the restraint is tightened. The buckle grip 14 may be padded; however, it is only necessary for the buckle grip 14 be shaped to conveniently be grasped by the operator's hand to maintain the position of the buckle during the tightening of the restraint.

It is important for the chest containment system to be snugly or firmly secured in place prior to the application of compression forces. That is, the restraint must be tightened about the victim's chest to insure the proper action of the restraint in the directing of push/pull forces subsequently to be applied by the operator or first responder. To assure that the tension is appropriate, and particularly in view of the belief that the tension must be greater on a larger individual with a large chest as opposed to a small individual (small woman or perhaps a child), the restraint 10 may be provided with a tension indicator 33 (FIG. 8) that provides an indication in window 34 of the tension in the restraint. That is, as the restraint is mounted and is tightened by the operator, an indication of the applied tension is displayed to the operator who may then further tighten or slightly loosen the restraint in accordance with the desired tension dictated by the size of the victim. A scale or table with appropriate tension values may be printed on a label adjacent to the end of the restraint in the view of the operator as the restraint is tightened on the victim to permit the proper selection and imposition of restraint tension.

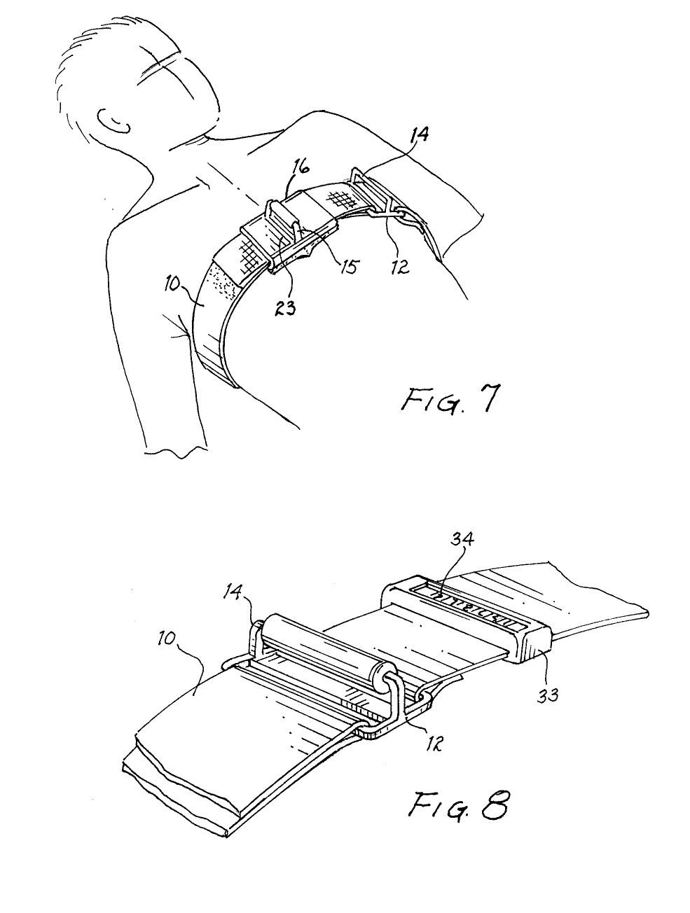

Referring to FIGS. 5 and 6, the handle portion of the chest containment system of the present invention is shown. The handle 15 may take any convenient shape and be constructed of any suitable material. In the embodiment chosen for illustration the handle 15 is formed of rigid plastic material formed to conveniently be grasped by an operator's hand. A padded grip 16 is provided to assist the positioning and grasping of the handle by the operator. The handle 15 includes a handle base 23 that in the embodiment chosen for illustration is an integrally molded rigid plastic rectangular member having a restraint engaging slot 20 extending sufficiently across the handle to receive the restraint 10. The slot is of sufficient depth to accommodate the double thickness of the restraint that is positioned over the patient's sternum when the restraint is placed on the patient.

The handle includes padding 17 that may be formed of a suitable material such as neoprene that contacts the patient's skin when the handle is positioned in contact with the patient's chest. The padding 17 includes a ridge 19 formed in the padding and extending parallel to the handle grip; the ridge is shaped to assist the positioning of the handle at the patient's sternum. The handle width 22 is sufficient to ensure that the corresponding width of the slot 20 can accommodate the width of the restraint when the handle is in position for CPR.

Referring to FIG. 7, a chest containment system constructed in accordance with the teachings of the present invention is shown properly mounted on the chest of a patient. The restraint 10 is appropriately positioned about the patient's chest and has been tightened to an appropriate tension by threading the loose restraint end through the buckle while the buckle is held in position toward the patient's left side by the operator's grasping the buckle grip, positioning the buckle, and maintaining the position of the buckle while the restraint loose end is pulled through the buckle and tensioned. A tension indicator 33 such as that shown in FIG. 8 may be incorporated to assist the first responder or operator in determining the appropriate tension for the physical characteristics of the patient involved. With the restraint loose end thus threaded through the buckle and the restraint tensioned appropriately, the restraint loose end is fastened by hook and loop surfaces between adjacent restraint surfaces. The handle is then positioned against the patient's chest with the ridge 19 formed in the padding of the handle base 23 aligned with the patient's sternum. With the padding 17 of the handle base in contact with the patient's chest, and the ridge 19 formed in the padding positioned as stated above, the handle is slid upwardly to the position shown in FIG. 7 wherein the handle 15 and the handle grip 16 are appropriately positioned with the handle base 23, and particularly the ridge 19 positioned in contact with the patient's sternum. In this position, the first responder or operator then grasps the grip and applies downward force against the patient's chest in a manner similar to that discussed above in connection with prior art manual CPR techniques. However, upon completion of the downward application of force, the operator then reverses the force and pulls the grip and handle upwardly away from the patient's sternum. The force applied by the operator during the downward and upward strokes of force application may be approximately the same; however, the direction of force transmitted to the patient's chest is reversed. During the downward application, force emanates from the handle base 23 through the padding 17 to the sternum area of the chest. The forces thus are directed centrally of the chest cavity downwardly into the chest cavity. Upon reversal of the operator's stroke, the force being applied by the handle to the sternum is eliminated and the force is instead transmitted through the restraint to the back and sides of the patient; that is, to the back and sides of the patient surrounding the chest cavity. The reversal of force applied to the patient increases perfusion thus rendering the CPR technique more effective.

As stated previously, the shape and size of the handle and handle base may vary, and the method of attachment of the handle to the restraint may vary. The positioning of the handle with respect to the patient is important such that the engagement of the handle to the restraint must be coordinated to permit the handle and the handle base to apply force to the sternum area of the patient's chest; therefore, it is important that the handle be positionable on the restraint and that the restraint and handle be positionable with respect to each other (the handle being able to be positioned at various locations along the restraint) to ensure that the handle is positioned at the patient's sternum after the restraint has been installed and resuscitation efforts are to begin.

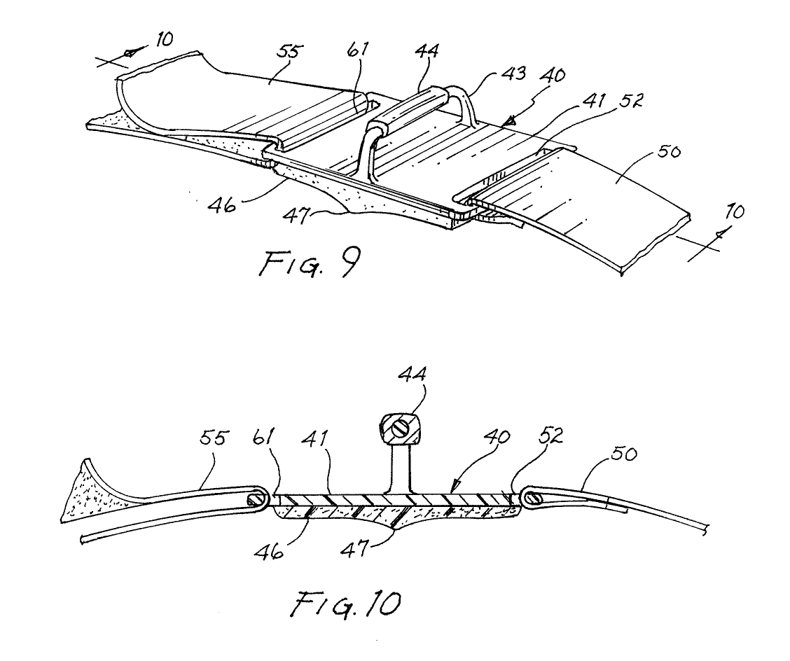

Referring to FIGS. 9 and 10, an alternative construction for practicing the method of the present invention is shown. The embodiment of FIG. 9 eliminates the independent buckle shown in the preceding embodiment; however, the handle is formed to perform both buckle and handle functions. The handle 40 includes a handle base 41 formed of suitable rigid plastic material and incorporating a handle grip 43 with suitable padding 44 to receive the first responder or operator's hand. The base 41 includes padding 46 having a ridge 47 to facilitate aligning the handle with the sternum of the patient. The restraint 50 is connected to the handle through the restraint receiving slot 52. This portion of the restraint is permanently affixed to the handle 40. The opposite end 55 of the restraint is threaded through a restraint receiving slot 61 provided in the handle base 41 to permit the restraint to be tightened as described in connection with the previous embodiment. After appropriately tensioning the restraint, the loose end of the restraint can be secured by hook and loop surfaces in a manner described in connection with the previous embodiment.

The present invention has been described in terms of selected specific embodiments of the apparatus and method incorporating details to facilitate the understanding of the principles of construction and operation of the invention. Such reference herein to a specific embodiment and details thereof is not intended to limit the scope of the claims appended hereto. It will be apparent to those skilled in the art that modifications may be made in the embodiments chosen for illustration without departing from the spirit and scope of the invention.

What is claimed is:

1. A chest containment system comprising:
(a) a restraint for circumscribing a patient's chest;
(b) a handle positionable over a patient's sternum in contact with said restraint; and
(c) said handle including a grip to be grasped by an operator or first responder to apply a downward force to compress the patient's chest to be followed by an upward force to tension the circumscribing restraint.

2. The chest containment system of claim 1 wherein said handle is positionable over a patient's sternum in contact with said restraint and in contact with said patient's sternum.

3. The chest containment system of claim 1 wherein said handle includes a base having a restraint receiving slot for engaging said restraint while contacting a patient's chest.

4. The chest containment system of claim 3 wherein said base includes padding for contacting the patient.

5. The chest containment system of claim 4 wherein said padding includes a ridge formed therein to facilitate positioning of said base at a patient's sternum.

6. A chest restraint system comprising:
(a) a restraint for circumscribing a patient's chest and having first and second ends;
(b) a buckle secured to said first end, said buckle having a loop and a grip to be grasped by an operator to place said buckle in a selected position against a patient's chest and held in that position while said second end is threaded through said loop; and
(c) a handle having a base including a restraint receiving slot for engaging said restraint while contacting a patient's chest.

7. The chest restraint system of claim 6 wherein said base includes padding for contacting the patient.

8. The chest restraint system of claim 7 wherein said padding includes a ridge formed therein to facilitate positioning of said base at a patient's sternum.

9. A chest restraint system comprising:
(a) a restraint for circumscribing a patient's chest and having first and second ends;
(b) a buckle secured to said first end, said buckle having a loop and a grip to be grasped by an operator to place said buckle in a selected position against a patient's chest and held in that position while said second end is threaded through said loop to form a double thickness portion of said restraint adjacent said buckle; and
(c) a handle having a base including a restraint receiving slot for engaging said double thickness portion of said restraint while contacting a patient's chest.

10. The chest restraint system of claim 9 wherein said base includes padding for contacting the patient.

11. The chest restraint system of claim 10 wherein said padding includes a ridge formed therein to facilitate positioning of said base at a patient's sternum.

12. A cardiopulmonary resuscitation method comprising:
(a) positioning a restraint about a patient's chest over the patient's sternum;
(b) tightening said restraint to a desired tension; and
(c) alternately applying force to the patient's chest at the sternum and reversing the force by grasping the restraint and lifting away from the chest.

13. A cardiopulmonary resuscitation method comprising:
(a) positioning a restraint about a patient's chest over the patient's sternum;
(b) tightening said restraint to a desired tension;
(c) securing a handle in contact with said restraint and over the patient's sternum; and
(d) grasping the handle and alternately applying force to the patient's chest at the sternum and reversing the force by lifting the handle and restraint away from the chest.
